(19) United States
(12) Patent Application Publication
(10) Pub. No.: US 2016/0117580 A1
(43) Pub. Date: Apr. 28, 2016

(54) METHOD AND SYSTEM FOR TRANSMITTING DATA USING VISUAL CODES

(71) Applicant: Morpho Detection, LLC, Newark, CA (US)

(72) Inventor: Aldo Napoleon Ortega, Mountain View, CA (US)

(21) Appl. No.: 14/947,283

(22) Filed: Nov. 20, 2015

Related U.S. Application Data
(62) Division of application No. 14/520,868, filed on Oct. 22, 2014.

(51) Int. Cl. G06K 19/06; G06F 21/31

(52) U.S. Cl. CPC G06K 19/06028; G06F 21/31; G06K 19/06112

(57) ABSTRACT

A method for transmitting data using a barcode is described. The method is implemented by a diagnostic computing device coupled to a display device. The method includes generating, by the diagnostic computing device, diagnostic data regarding at least a first machine. The method additionally includes encoding at least a portion of the diagnostic data in at least one barcode and displaying the at least one barcode using the display device.

### BACKGROUND OF THE INVENTION

The embodiments described herein relate generally to transmitting data, and more particularly to transmitting data using visual codes.

At least some known machines, such as computed tomography machines used for baggage scanning in airports, are isolated from computer networks to reduce the likelihood of a virus or other malware affecting the operations of the machines. In some known systems, when performing maintenance on such a machine, a field service technician uses portable data storage media, such as a portable flash drive, to retrieve diagnostics data from the machine and load the diagnostics data onto a mobile computing device operated by the technician. The technician then transmits the diagnostic data from the mobile computing device to a remote server system operated by a manufacturer or technical support team for further analysis. However, it is possible that such portable storage media may still include malware that could inadvertently be loaded by the machine and affect its operation. In other known systems, a technician views data displayed on a display device of such a machine and manually inputs the data into the mobile computing device, then transmits the data from the mobile computing device to the remote server system. It would be beneficial for such machines to be able to conveniently package and transmit diagnostic data in a manner that does not expose them to malware and does not require laborious input of data by a technician.

### BRIEF DESCRIPTION OF THE INVENTION

In one aspect, a method for transmitting data using a barcode is provided. The method is implemented by a diagnostic computing device coupled to a display device. The method includes generating, by the diagnostic computing device, diagnostic data regarding at least a first machine. The method additionally includes encoding at least a portion of the diagnostic data in at least one barcode and displaying the at least one barcode using the display device.

In another aspect, a diagnostic computing device for transmitting data using a barcode is provided. The diagnostic computing device includes a processor coupled to a display device. The processor is configured to generate diagnostic data regarding at least a first machine, encode at least a portion of the diagnostic data in at least one barcode, and display the at least one barcode using the display device.

In another aspect, a method for receiving diagnostic data using a barcode is provided. The method is implemented by a maintenance computing device. The method includes receiving, by the maintenance computing device, an image of a barcode. The method additionally includes decoding diagnostic data encoded in the barcode and displaying the diagnostic data in a human-readable format.

### BRIEF DESCRIPTION OF THE DRAWINGS

FIG. 1 is a block diagram of an environment that includes a machine that includes a diagnostic computing device, a mobile computing device that scans a non-human-readable visual code generated by the diagnostic computing device, and a server computing device that receives the non-human-readable visual code.

FIG. 2 is a block diagram of an example client computing device used in the environment shown in FIG. 1.

FIG. 3 is a block diagram of the server computing device used in the environment shown in FIG. 1.

FIG. 4 is a diagram of data included in the non-human-readable visual code generated by the diagnostic computing device shown in FIG. 1.

FIG. 5 is a diagram of a user interface for displaying diagnostic data encoded in the non-human-readable visual code of FIG. 1.

FIG. 6 is a flow chart of an example process performed by the diagnostic computing device shown in FIG. 1 for transmitting data using a barcode.

FIG. 7 is a flow chart of an example process performed by the server computing device shown in FIG. 1 for receiving diagnostic data using a barcode.

### DETAILED DESCRIPTION OF THE INVENTION

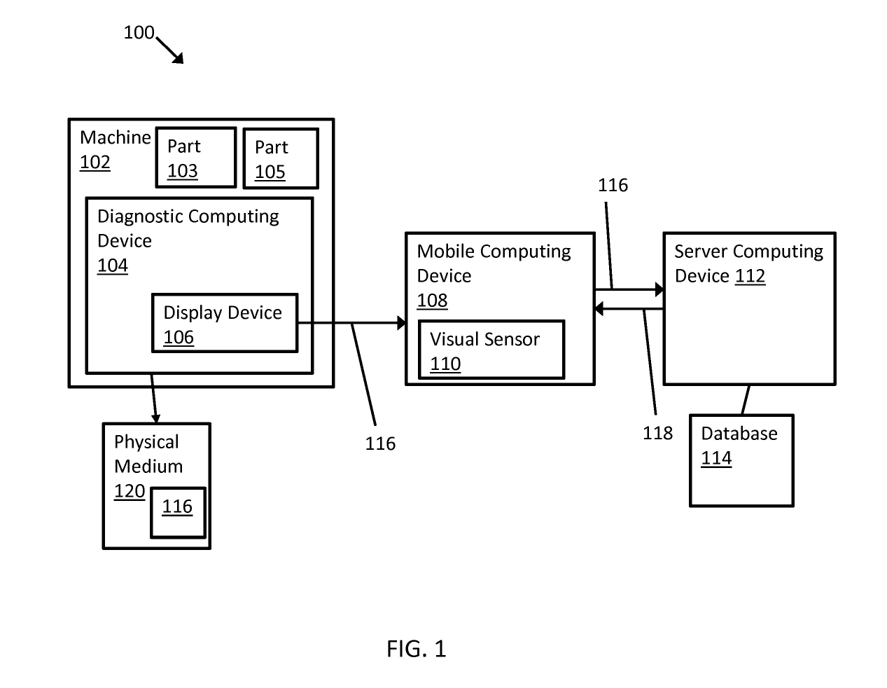

FIG. 1 is a block diagram of an environment 100 that includes a machine 102. In some implementations, machine 102 is a threat detection system, such as a computed tomography scanning system that detects contraband in luggage. In other implementations, machine 102 carries out any other function consistent with the systems and methods described herein. In some implementations, machine 102 includes a first part 103 and a second part 105. For example, in some implementations, first part 103 is an electromagnetic radiation emitter and second part 105 is an electromagnetic radiation detector. Additionally, machine 102 includes a diagnostic computing device 104. In some implementations, rather than being included within machine 102, diagnostic computing device 104 is coupled to machine 102. Diagnostic computing device 104 is configured to generate diagnostic data and encode the diagnostic data in one or more non-human-readable visual codes 116, as described in more detail herein. Diagnostic computing device 104 includes or is coupled to a display device 106. In at least some implementations, machine 102 and diagnostic computing device 104 are not communicatively coupled to any other computing devices.

Environment 100 additionally includes a mobile computing device 108. Mobile computing device 108 includes a visual sensor 110, such as a camera or barcode scanner. Additionally, environment 100 includes a server computing device 112 that is communicatively coupled to mobile computing device 108. Additionally, server computing device 112 is in communication with a database 114. In at least some implementations, diagnostic computing device 104 generates and displays a non-human-readable visual code 116, such as a barcode, using display device 106. The non-human-readable visual code 116 encodes diagnostic data generated by diagnostic computing device 104. Mobile computing device 108 receives non-human-readable visual code 116 by, for example, taking a picture of or scanning non-human-readable visual code 116 from display device 106.

In at least some implementations, mobile computing device 108 then transmits non-human-readable visual code 116 to server computing device 112. In response, server computing device 112 transmits responsive data 118 to mobile computing device 108. In some implementations, responsive data 118 includes an acknowledgement that server computing device 112 received non-human-readable visual code 116. In some implementations, non-human-readable visual code 116 encodes diagnostic data that includes an indication of a problem with first part 103 and/or second part 105. After receiving non-human-readable visual code 116 from mobile computing device 108, server computing device 112 decodes non-human-readable visual code 116, references database 114 for a solution to the problem, and transmits the solution to mobile computing device 108 in responsive data 118. In other implementations, non-human-readable visual code 116 encodes diagnostic data that includes a request to order a replacement part (e.g., first part 103 and/or second part 105) and responsive data 118 includes an approval to order the replacement part. In some implementations, diagnostic computing device 104 prints non-human-readable visual code 116 onto a physical medium 120, such as paper or an adhesive label to be affixed to the part to be replaced (e.g., first part 103 and/or second part 105).

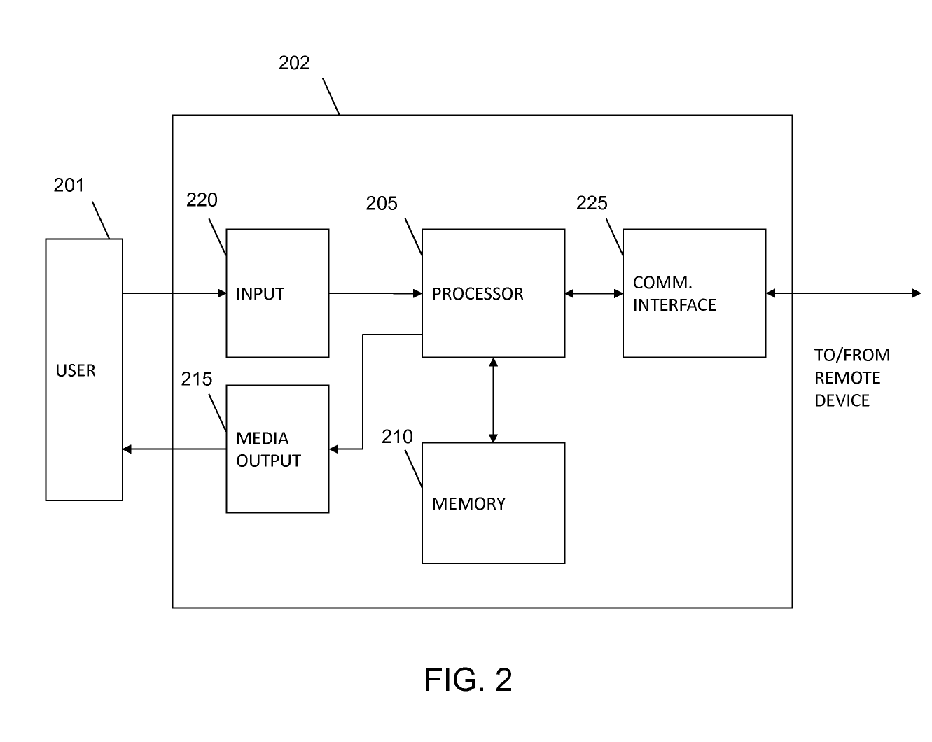

FIG. 2 illustrates an example configuration of a client computing device 202 operated by a user 201. Client computing device 202 is representative of diagnostic computing device 104 and mobile computing device 108. Client computing device 202 includes one or more processors 205 for executing instructions. In some embodiments, executable instructions are stored in a memory area 210. Processor 205 may include one or more processing units (e.g., in a multi-core configuration). One or more memory devices 210 are any one or more devices allowing information such as executable instructions and/or other data to be stored and retrieved. One or more memory devices 210 may include one or more computer-readable media.

Client computing device 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device (e.g. display device 106) or an audio output device (e.g., a speaker or headphones). The display device may be, for example, a liquid crystal display (LCD), organic light emitting diode (OLED) display, cathode ray tube (CRT), or “electronic ink” display.

In some embodiments, client computing device 202 includes an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, an audio input device, a camera or other visual sensor, a barcode scanner, a magnetic sensor, and/or an radio frequency sensor. A single component such as a touch screen may function as both an output device of media output component 215 and input device 220.

Client computing device 202 may also include a communication interface 225, which is communicatively couplable to remote devices such as server computing device 112. Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)). In at least some implementations, diagnostic computing device 104 does not include communication interface 225.

Stored in one or more memory devices 210 are, for example, computer-readable instructions for providing a user interface to user 201 via media output component 215 and, optionally, receiving and processing input from input device 220. A user interface may display information to user 201 and/or enable user 201 to enter information into client computing device 202.

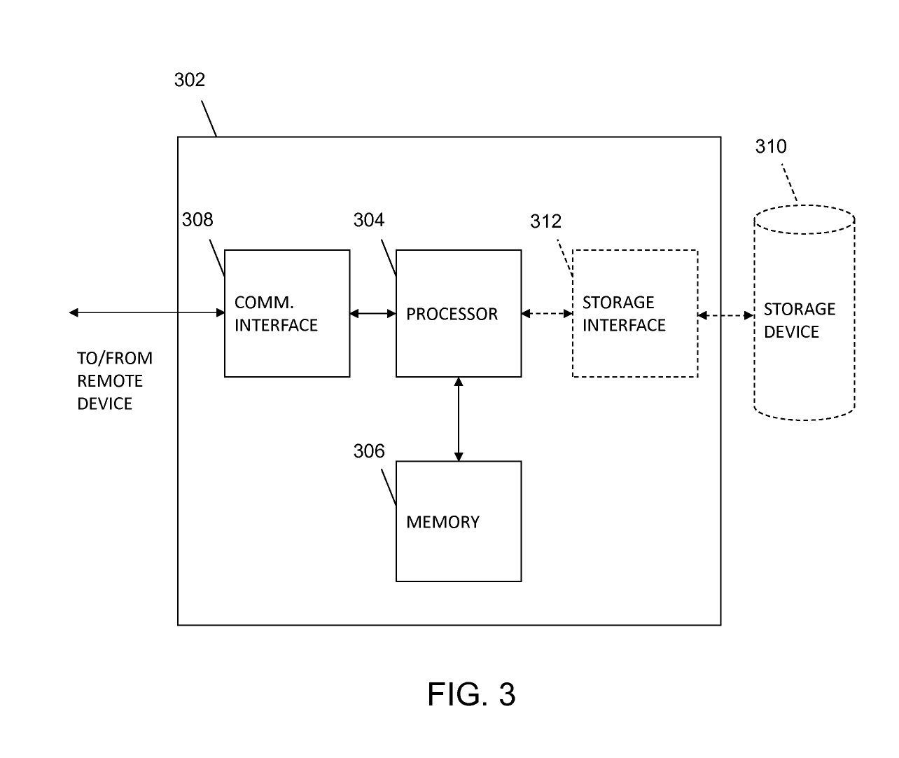

FIG. 3 illustrates an example configuration of a server computing device 302 such as server computing device 112 (shown in FIG. 1). Server computing device 302 includes one or more processors 304 for executing instructions. Instructions may be stored in one or more memory devices 306. One or more processors 304 may include one or more processing units (e.g., in a multi-core configuration).

One or more processors 304 are operatively coupled to a communication interface 308 such that server computing device 302 is capable of communicating with a remote device such as client computing device 202 or another server computing device 302. For example, communication interface 308 may receive data from mobile computing device 108 via the Internet or another network.

One or more processors 304 may also be operatively coupled to one or more storage devices 310. One or more storage devices 310 are any computer-operated hardware suitable for storing and/or retrieving data. In some embodiments, one or more storage devices 310 are integrated in server computing device 302. For example, server computing device 302 may include one or more hard disk drives as one or more storage devices 310. In other embodiments, one or more storage devices 310 are external to server computing device 302 and may be accessed by a plurality of server computing devices 302. For example, one or more storage devices 310 may include multiple storage units such as hard disks or solid state disks in a redundant array of inexpensive disks (RAID) configuration. One or more storage devices 310 may include a storage area network (SAN) and/or a network attached storage (NAS) system. In some embodiments, one or more storage devices 310 include database 114.

In some embodiments, one or more processors 304 are operatively coupled to one or more storage devices 310 via a storage interface 312. Storage interface 312 is any component capable of providing one or more processors 304 with access to one or more storage devices 310. Storage interface 312 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing one or more processors 304 with access to one or more storage devices 310.

One or more memory devices 210 and 306 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

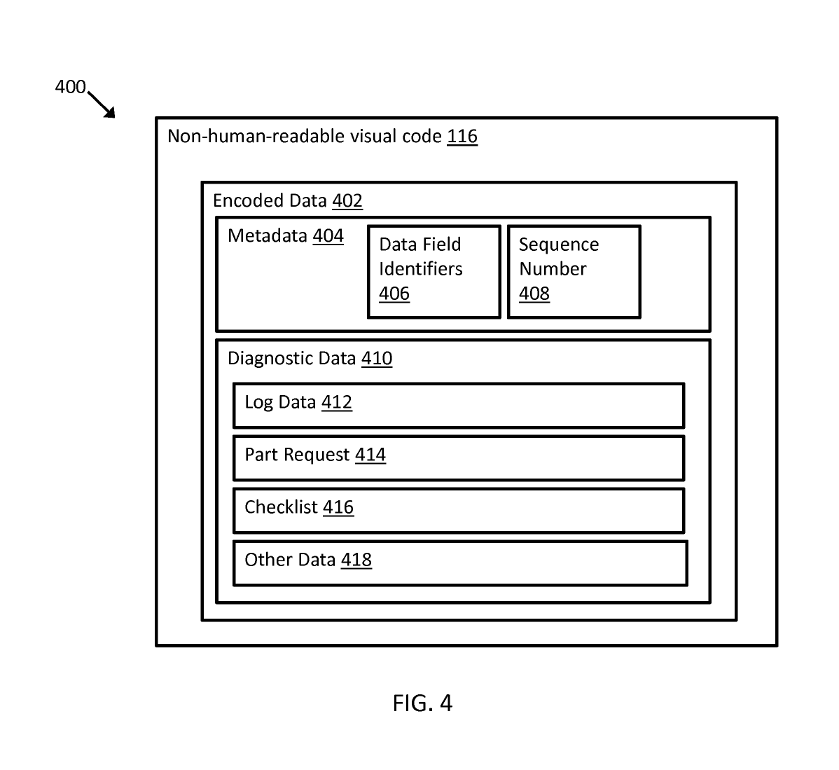

FIG. 4 is a diagram 400 of data included in non-human-readable visual code 116 generated by diagnostic computing device 104. Non-human-readable visual code 116 includes encoded data 402. In some implementations, diagnostic computing device 104 encrypts encoded data 402 based, for example, on a password. In some implementations, encoded data 402 includes metadata 404 that includes information that describes diagnostic data 410. For example, in some implementations, metadata 404 includes one or more data field identifiers 406. Data field identifiers 406, in some implementations, define one or more fields of data represented in diagnostic data 410 and one or more delimiters (e.g., commas) used to separate each field. In some implementations, metadata 404 includes a sequence number 408 that indicates a position of diagnostic data 410 in a sequence. For example, in some implementations, diagnostic computing device 104 generates a plurality of non-human-readable visual codes 116 in a sequence, wherein each non-human-readable visual codes 116 includes a different portion of a set of diagnostic data 410. In such implementations, sequence number 408 identifies where a particular set of diagnostic data 410 encoded in a particular non-human-readable visual code 116 is positioned within the sequence.

Diagnostic data 410 includes one or more of log data 412, a part request 414, a checklist 416, and other data 418. Log data 412 includes status messages and/or error messages generated by diagnostic computing device 104 during operation of machine 102. For example, in some implementations, diagnostic computing device 104 stores a log of status messages and/or error messages in memory 210 during operation of machine 102. In some implementations, diagnostic computing device 104 filters the log, for example to exclude any messages that do not pertain to an error, and encodes one or more error messages in log data 412.

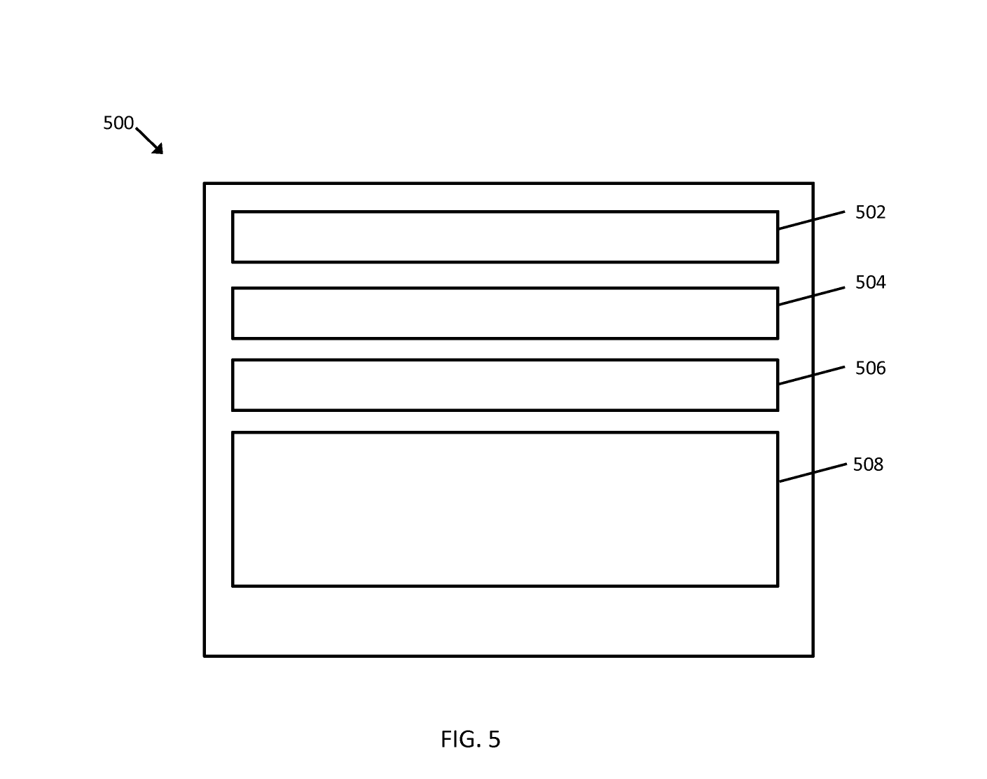

Part request 414 includes an identification of a part, for example first part 103 of machine 102, and a request for authorization to order a replacement for the part. In some implementations, diagnostic computing device 104 displays a user interface, such as user interface 500 (FIG. 5), and a technician (e.g., user 201) provides data to diagnostic computing device 104 for part request 414 using user interface 500 (FIG. 5). Checklist 416 includes descriptions of one or more maintenance or diagnostic tasks to be performed by a technician. As described above, encoded data 402 may additionally or alternatively include other data 418. For example, in some implementations, metadata 404 describes the nature of other data 418 and/or how other data 418 is to be parsed and/or displayed by a computing device that decodes encoded data 402 (e.g., server computing device 112).

FIG. 5 is a diagram of user interface 500, which displays diagnostic data 410. User interface 500 may be displayed by diagnostic computing device 104 (e.g., using display device 106) and/or by server computing device 112. More specifically, a technician (e.g., user 201) may enter data into one or more of a first field 502, a second field 504, a third field 506, and a fourth field 508 on diagnostic computing device 104. For example, a technician may enter data pertaining to a part request 414, a checklist 416, and/or other data 418 (FIG. 4), which diagnostic computing device 104 then encodes into non-human-readable visual code 116. Conversely, in at least some implementations, after receiving non-human-readable visual code 116, server computing device 112 decodes non-human-readable visual code 116 and displays diagnostic data 410 in user interface 500. More specifically, in at least some implementations, server computing device 112 refers to metadata 404 to determine how to parse diagnostic data 410, and then populates first field 502, second field 504, third field 506, and/or fourth field 508 with corresponding diagnostic data 410 encoded in non-human-readable visual code 116.

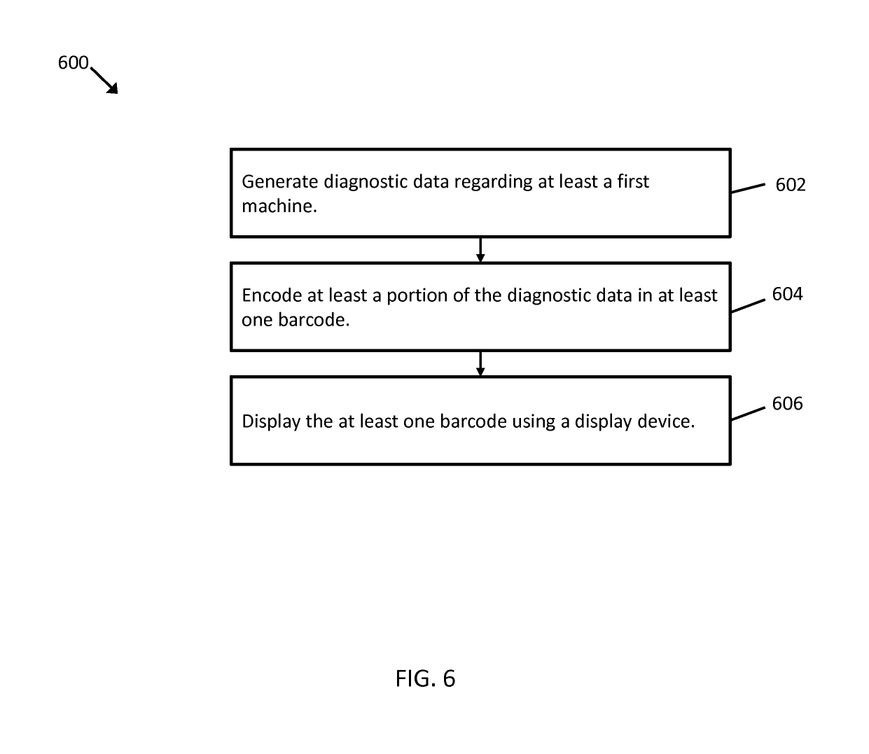

FIG. 6 is a flow chart of an example process 600 performed by diagnostic computing device 104 for transmitting data (e.g., diagnostic data 410) using a barcode (e.g., non-human-readable visual code 116). Initially, diagnostic computing device 104 generates 602 diagnostic data (e.g., diagnostic data 410) regarding at least a first machine (e.g., machine 102). Additionally, diagnostic computing device 104 encodes 604 at least a portion of the diagnostic data (e.g., diagnostic data 410) in at least one barcode (e.g., non-human-readable visual code 116). Additionally, diagnostic computing device 104 displays 606 the at least one barcode (e.g., non-human-readable visual code 116) using a display device (e.g., display device 106).

In some implementations, diagnostic computing device 104 encrypts at least a portion of the diagnostic data (e.g., diagnostic data 410) prior to encoding the diagnostic data (e.g., diagnostic data 410). In some implementations, diagnostic computing device 104 encodes the at least a portion of the diagnostic data (e.g., diagnostic data 410) by encoding a first portion of the diagnostic data (e.g., diagnostic data 410) in a first barcode (e.g., non-human-readable visual code 116) and encoding a second portion of the diagnostic data (e.g., diagnostic data 410) in a second barcode (e.g., non-human-readable visual code 116).

In some implementations, diagnostic computing device 104 encodes data field identifiers (e.g., data field identifiers 406) associated with the at least a portion of the diagnostic data (e.g., diagnostic data 410) in the at least one barcode (e.g., non-human-readable visual code 116). In some implementations, diagnostic computing device 104 encoding at least a portion of the diagnostic data (e.g., diagnostic data 410) by encoding each of a plurality of portions of the diagnostic data (e.g., diagnostic data 410) in a sequence of barcodes and storing a sequence number (e.g., sequence number 408) in each of the barcodes corresponding to a position of the respective portion of the diagnostic data (e.g., diagnostic data 410) within the sequence. In some implementations, diagnostic computing device 104 displays each of the barcodes (e.g., non-human-readable visual code 116) according to the sequence.

In some implementations, diagnostic computing device 104 prints the barcode (e.g., non-human-readable visual code 116) to a physical medium (e.g., physical medium 120). For example, in some implementations, physical medium 120 is an adhesive that is attached to a part (e.g., first part 103) to be replaced. In some implementations, diagnostic computing device 104 encodes at least a portion of the diagnostic data (e.g., diagnostic data 410) in at least one barcode (e.g., non-human-readable visual code 116) by encoding the at least a portion of the diagnostic data (e.g., diagnostic data 410) in at least one two-dimensional barcode (e.g., non-human-readable visual code 116). In some implementations, diagnostic computing device 104 encodes at least a portion of the diagnostic data (e.g., diagnostic data 410) in a quick response (QR) code (e.g., non-human-readable visual code 116). In some implementations, diagnostic computing device 104 encodes at least one maintenance checklist (e.g., checklist 416) into a second barcode (e.g., non-human-readable visual code 116) and displays the second barcode (e.g., non-human-readable visual code 116) using the display device (e.g., display device 106).

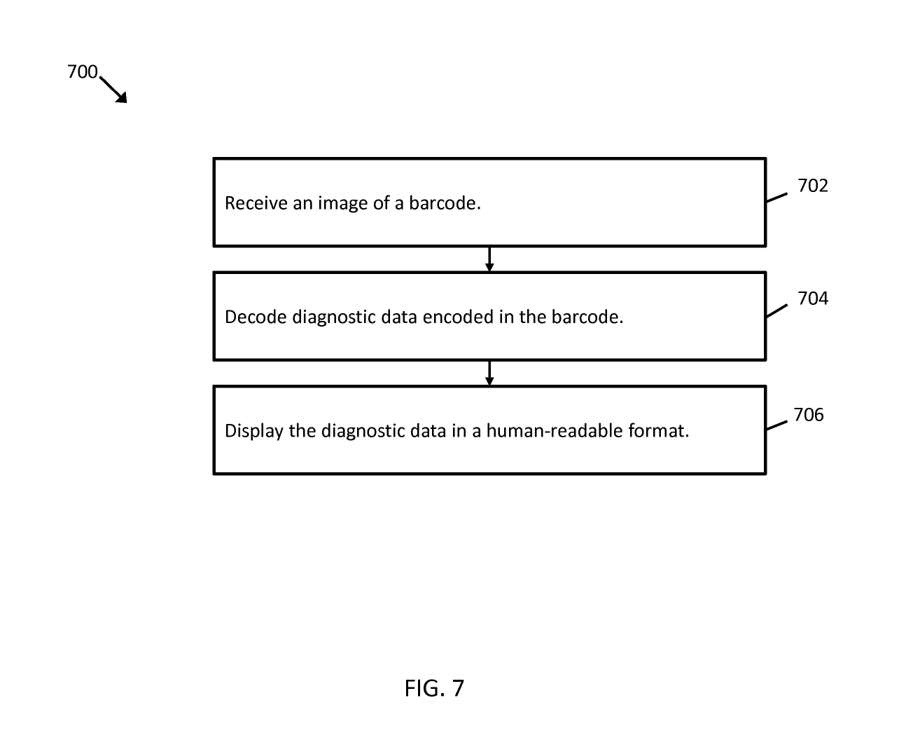

FIG. 7 is a flow chart of an example process 700 performed by the server computing device 112 (also referred to herein as a “maintenance computing device”) for receiving diagnostic data (e.g., diagnostic data 410) using a barcode (e.g., non-human-readable visual code 116). Initially, server computing device 112 receives 702 an image of a barcode (e.g., non-human-readable visual code 116). For example, server computing device 112 receives the image from mobile computing device 108. Additionally, server computing device 112 decodes 704 diagnostic data (e.g., diagnostic data 410) that is encoded in the barcode (e.g., (e.g., non-human-readable visual code 116). Additionally, server computing device 112 displays 706 the diagnostic data (e.g., diagnostic data 410) in a human-readable format. For example, in some implementations, server computing device 112 displays the diagnostic data (e.g., diagnostic data 410) in user interface 500.

In some implementations, server computing device 112 extracts an identification of a diagnostic issue from the diagnostic data (e.g., from log data 412) and transmits responsive data (e.g., responsive data 118) to mobile computing device 108. In some implementations, responsive data 118 includes at least one solution to the diagnostic issue. In some implementations, server computing device 112 extracts, from the diagnostic data (e.g., diagnostic data 410), an identification of at least one component (e.g., first part 103 and/or second part 105) of a machine to be replaced, for example in part request 414. In some implementations, server computing device 112 displays a user interface (e.g., user interface 500) that includes at least one field (e.g., first field 502) pertaining to maintenance of a machine (e.g., machine 102) and populates the at least one field (e.g., first field 502) using the diagnostic data (e.g., diagnostic data 410). In some implementations, server computing device 112 receives a password using an input device (e.g., input device 220) and decrypts the diagnostic data (e.g., diagnostic data 410) using the password.

It should be understood that processor as used herein means one or more processing units (e.g., in a multi-core configuration). The term processing unit, as used herein, refers to microprocessors, microcontrollers, reduced instruction set circuits (RISC), application specific integrated circuits (ASIC), logic circuits, and any other circuit or device capable of executing instructions to perform functions described herein.

It should be understood that references to memory mean one or more devices operable to enable information such as processor-executable instructions and/or other data to be stored and/or retrieved. Memory may include one or more computer readable media, such as, without limitation, hard disk storage, optical drive/disk storage, removable disk storage, flash memory, non-volatile memory, ROM, EEPROM, random access memory (RAM), and the like.

Additionally, it should be understood that communicatively coupled components may be in communication through being integrated on the same printed circuit board (PCB), in communication through a bus, through shared memory, through a wired or wireless data communication network, and/or other means of data communication. Additionally, it should be understood that data communication networks referred to herein may be implemented using Transport Control Protocol/Internet Protocol (TCP/IP), User Datagram Protocol (UDP), or the like, and the underlying connections may comprise wired connections and corresponding protocols, for example, Institute of Electrical and Electronics Engineers (IEEE) 802.3 and/or wireless connections and associated protocols, for example, an IEEE 802.11 protocol, an IEEE 802.15 protocol, and/or an IEEE 802.16 protocol.

A technical effect of systems and methods described herein includes at least one of: (a) generating diagnostic data regarding at least a first machine; (b) encoding at least a portion of the diagnostic data in at least one barcode; (c) displaying the at least one barcode using a display device; (d) receiving an image of a barcode; (e) decoding diagnostic data encoded in the barcode; and (f) displaying the diagnostic data in a human-readable format.

As compared to known systems for transferring diagnostic data from a first computing device to a second computing device, the systems and methods described herein enable a first computing device to transmit diagnostic data to a second computing device without requiring a network connection to the second computing device and without requiring the transfer of physical storage media between the first computing device and the second computing device.

Exemplary embodiments of systems and methods for transmitting diagnostic data using a non-human-readable visual code are described above in detail. The methods and systems are not limited to the specific embodiments described herein, but rather, components of systems and/or steps of the methods may be utilized independently and separately from other components and/or steps described herein. For example, the methods may also be used in combination with other systems and methods, and are not limited to practice with only the systems as described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-15. (canceled)

16. A method for receiving diagnostic data using a barcode, said method is implemented by a maintenance computing device, said method comprising:
receiving, by the maintenance computing device, an image of a barcode;
decoding diagnostic data encoded in the barcode; and
displaying the diagnostic data in a human-readable format.

17. The method of claim 16, wherein said maintenance computing device is communicatively coupled to a mobile computing device, said method further comprising:
extracting an identification of a diagnostic issue from the diagnostic data; and
transmitting responsive data to the mobile computing device, the responsive data including at least one solution to the diagnostic issue.

18. The method of claim 16, further comprising extracting from the diagnostic data an identification of at least one component of a machine to be replaced.

19. The method of claim 16, further comprising:
displaying a user interface that includes at least one field pertaining to maintenance of a machine; and
populating the at least one field using the diagnostic data.

20. The method of claim 16, wherein said maintenance computing device further includes an input device, said method further comprising:
receiving a password using the input device; and
decrypting the diagnostic data using the password.

21. The method of claim 16, wherein receiving the image of the barcode includes receiving a first barcode that encodes a first portion of the diagnostic data, the method further comprising:
receiving, by the maintenance computing device, an image of a second barcode;
decoding diagnostic data encoded in the second barcode, the second barcode encoding a second portion of the diagnostic data.

22. The method of claim 21, wherein decoding the diagnostic data further comprises:
determining a sequence number in each of the barcodes corresponding to a position of the respective portion of the diagnostic data within a sequence; and
decoding each of a plurality of portions of the diagnostic data according to the sequence of barcodes.

23. The method of claim 16, wherein decoding diagnostic data encoded in the barcode further comprises decoding diagnostic data encoded in the barcode wherein the barcode includes a two-dimensional barcode.

24. The method of claim 16, wherein decoding diagnostic data encoded in the barcode further comprises decoding diagnostic data in the barcode wherein the barcode includes a quick response (QR) code.

25. The method of claim 16, further comprising decoding at least one maintenance checklist from the barcode.
